(19) United States
(12) Patent Application Publication
(10) Pub. No.: US 2015/0235281 A1
(43) Pub. Date: Aug. 20, 2015

(54) CATEGORIZING DATA BASED ON CROSS-CATEGORY RELEVANCE

(71) Applicant: Amazon Technologies, Inc., Reno, NV (US)

(72) Inventors: Sarthak Jain, Raipur (IN); Poornachandra Rao Purushottama Pesala, Hyderabad (IN); Sagar Chodapaneedi, Rajahmundry (IN)

(21) Appl. No.: 14/305,624

(22) Filed: Jun. 16, 2014

(30) Foreign Application Priority Data
Feb. 14, 2014 (IN) 698/CHE/2014

(51) Int. Cl. G06Q 30/02; G06F 17/30; G06F 17/27

(52) U.S. Cl. CPC G06Q 30/0282; G06F 17/2705; G06F 17/3053; G06F 17/30867

(57) ABSTRACT

Techniques for auto-categorization data may be provided. For example, a computing service may be implemented to analyze data sets. A first data set may include data strings pre-categorized in various groups. For a group, the computing service may generate a relevant data string representative of the group by considering how relevant that data string may be to the group and to other groups. A second data set may include an uncategorized data string. The computing service may match the uncategorized data string to the relevant data string and, accordingly, may categorize the uncategorized data string as belonging to the group.

### CROSS REFERENCE TO RELATED APPLICATIONS

This application claims the benefit of Indian Patent Application No. 698/CHE/2014, filed Feb. 14, 2014, entitled “CATEGORIZING DATA BASED ON CROSS-CATEGORY RELEVANCE,” which is incorporated herein by reference in its entirety.

### BACKGROUND

An electronic marketplace of a service provider may be configured to enable merchants to provide items to consumers. The consumers may leave reviews of the items at the electronic marketplace. These reviews may relate to the merchants, the items, methods of providing the items, and/or other item-related reviews. Typically, the service provider and the merchants may require that representative reviews be properly provided to potential consumers. That may be because the potential consumers may rely on the reviews when making purchasing decisions. As the number of merchants, items, and consumers increases and, subsequently, the number of the reviews increases, the service provider may face challenges.

### BRIEF DESCRIPTION OF THE DRAWINGS

Various embodiments in accordance with the present disclosure will be described with reference to the drawings, in which:

FIG. 1 illustrates an example computing environment of auto-categorizing data, according to embodiments;

FIG. 2 illustrates an example flow for auto-categorizing data, according to embodiments;

FIG. 3 illustrates an example architecture for auto-categorizing data, including at least one user device and/or one or more service provider computers connected via one or more networks, according to embodiments;

FIG. 4 illustrates an example flow for predefining categories, according to embodiments;

FIG. 5 illustrates an example flow for generating potential representative data of a category, according to embodiments;

FIG. 6 illustrates an example construction of a potential representative data of a category, according to embodiments;

FIG. 7 illustrates an example flow for determining whether potential representative data of a category may be an actual representative data of the category, according to embodiments;

FIG. 8 illustrates an example flow for performing an action on data based on an actual representative data of a category, according to embodiments; and

FIG. 9 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, auto-categorizing of data and performing related actions. In an example, a service provider of an electronic marketplace may utilize an electronic service to auto-categorize consumer reviews related to transactions facilitated by way of the electronic marketplace. The electronic service may consider various groups of data such as groups of consumer reviews related to merchants and item deliveries. A merchants group may include a number, perhaps thousands or more, of consumer reviews that may describe the merchants. Likewise, an item deliveries group may include similar numbers of consumer reviews but may describe the deliveries of the items. These reviews may typically include sentences constructed using day-to-day words. To determine key phrases for each group where the key phrases may represent the consumer reviews in that group, the electronic service may implement a multi-factor process. The electronic service may combine, from each group, words to generate potential phrases. Next, the electronic service may determine how relevant each potential phrase may be for each group. The relevancy of a potential phrase for a particular group may be based on a probability of use of the potential phrase in the consumer reviews of the particular group. Further, the electronic service may consider the relevancies of each potential phrase across the groups to generate a relevancy score per group for that potential phrase. As such and for each group, the electronic service may determine a number of potential phrases with relevancy scores and may set those potential phrases as the key phrases representative of the consumer reviews in that group. When a new consumer review is received, the electronic service may match the new consumer review to one or more of the key phrases and may accordingly categorize the new consumer review in the corresponding one or more groups. For example, if a consumer review matches a key phrase of the merchants group, that consumer review may be automatically categorized as belonging to the merchants group. Further, the electronic service may implement a set of rules that may define what actions may be performed on the consumer reviews based on the key phrases. For example, the rules may specify that a request from a merchant for removing a consumer review from publication at the electronic marketplace may be granted if the consumer review is not categorized under the merchants group. Otherwise, the request should be denied.

To illustrate, the electronic service may determine that the key phrases of the merchants group and the items deliveries group include “item provided matches description” and “item received on/not on time,” respectively. Toni may offer to sell cameras at the electronic marketplace. Jesse, a camera enthusiast may use the electronic marketplace to purchase a camera from Toni. Although Toni may have promptly shipped the camera, the camera may arrive two weeks late to Jesse's address for reasons caused by the delivery carrier. Dissatisfied with this experience, Jesse may leave a negative consumer review for Toni at the electronic marketplace such as “do not buy a camera from Toni. I bought one but I got it two weeks late.” Nervous about the impact to business, Toni may submit a request at the electronic marketplace for removing the negative consumer review believing that the issue should be more properly characterized as a carrier delivery issue. In turn, the electronic service may match Jesse's review to the “item received on/not on time” key phrase and may accordingly categorize the review under the item deliveries group. Further, based on the set of rules, the electronic service may remove Jesse's review by, for example, disassociating the review from Toni and, instead, associating the review with a delivery issue.

In the interest of clarity of explanation, the embodiments are described in the context of an electronic marketplace, service providers, items, merchants, consumers, and consumer reviews. Nevertheless, the embodiments may be applied to any network-based resource (e.g., a web site), any item that may be tangible (e.g., a product) or intangible (e.g., a service), any service provider (e.g., a provider of a network-based resource, or a provider that may facilitate providing of an item), any merchant (e.g., an item provider, a seller, or any user offering an item at the electronic marketplace), any consumer (e.g., an item recipient, a buyer, or any user reviewing, ordering, obtaining, purchasing, or returning an item), and/or any consumer review (e.g., a review associated with a network-based resource, an item, a service provider, a merchant, a consumer, a delivery of an item, or other reviews).

More particularly, and as explained above, the embodiments herein may allow auto-categorization of information in categories. Generally, information may include strings of elements, which may be referred to herein as portions of information. An element may include a readable object such as a character, a word, a text and/or other types of readable object. A string of readable objects may include sentences, phrases, expressions, and/or other types of strings. As such, techniques described in the embodiments herein may not only apply to auto-categorization of consumer reviews, but may also apply to auto-categorization of various information types. For example, the techniques may be similarly applied to auto-categorize a document based on the document content, comments to an article such as a news report, texts from a blog, messages within a social network content, consumer complaints, surveys completed by users, or other types of data. In an example, a consumer complaint submitted at a network-based resource of a company, such as at a consumer service web page, may be auto-categorized and routed to a proper group of the company based on the associated category. Hence, a consumer complaint related to a technical service may be routed to a technical focal while a consumer complaint related to a billing issue may be routed to a financial focal.

Further, the readable objects and the strings of readable objects may be expressed in various languages such as a written language (e.g., English, Spanish, India), a computer language (e.g., C, C++), and other languages. The techniques may be agnostic of the underlying language. In other words, the accuracy of the auto-categorization may not depend on or may not vary with the language that the information may be written in.

To illustrate, a data manager may utilize an electronic service to auto-categorize information in a large data set and to define actions applicable to categorized information. The electronic service may be configured to consider groups of information, where each group may represent a category of information and may be associated with a label representative of the category. The groups, categories, and labels may be predefined and selected from an existing set of information for training the electronic service. The electronic service may be further configured to, for each group, parse the information to determine elements (e.g., portions) of the information, combine the elements to generate strings of elements, and to determine relevance of each generated string relative to the group and to the other groups. This intra and cross-group determination may allow the electronic service to determine a number of most relevant strings of elements per group. In other words, a string of elements that may be relevant to two or more groups may not be a most relevant string for any group. In comparison, a string of elements highly relevant to one particular group but not to other ones may be one of the most relevant strings for that particular group. As such, the electronic service may represent each group by the corresponding most relevant strings of elements. For other uncategorized information, such as newly received information, the electronic service may parse this information to determine the corresponding elements and may match the elements to one or more of the most relevant string of elements. Based on the matching, the electronic service may categorize the uncategorized data in one or more groups corresponding to the one or more matched relevant strings of elements. Once categorized, the electronic service may perform a number of actions on the data based on the associated category and label, such as data storing, deleting, publishing, and/or other data-related actions. These and other features are further described in the figures herein below.

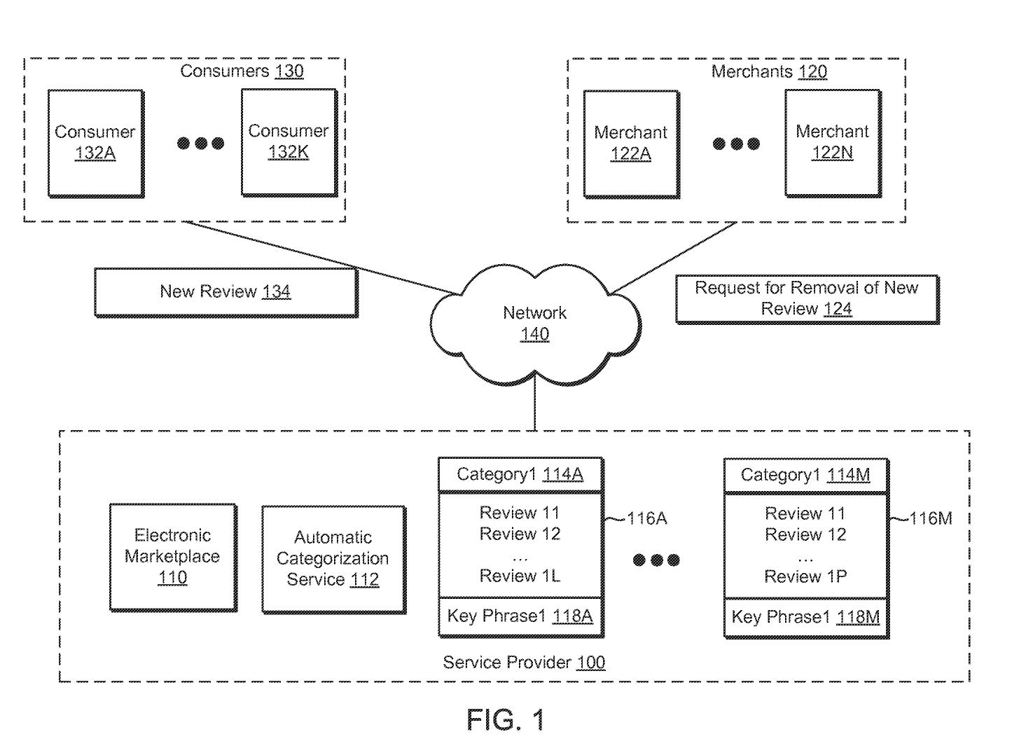

Turning to FIG. 1, that figure illustrates an example computing environment for implementing the techniques described herein. In particular, the illustrated computing environment may be configured to allow a service provider 100 of an electronic marketplace 110 to implement an automatic categorization service 112 such as the electronic service described herein above. The auto-categorization service 112 may automatically categorize consumer reviews provided by consumers 130 at the electronic marketplace 110 and may enable actions to be performed on the categorized consumer reviews based on a set of rules. The auto-categorization service 112 may be integrated with components of the electronic marketplace 110. In other words, the service provider 100 may set-up the auto-categorization service 112 as an inherent electronic service of the electronic marketplace 110.

More particularly, the service provider 100, the merchants 120, and the consumers 130 may operate various types of computing devices to connect over a network 140. The service provider 100 may configure the electronic marketplace 110 to provide various functions and features to the merchants 120 and consumers 130, including for example, allowing the merchants 120 to offer items at the electronic marketplace 110 and the consumers 130 obtain and review the items from the merchants 120 by way of the electronic marketplace 110.

As shown, there may be a large number of merchants 122A-122N. Each of the merchants may offer various items. The items may be offered not only at various prices, but also with various contexts such as delivery methods, warranties, return policies, customer service support, and other merchant-related contexts. Similarly, there may be a large number of consumers 132A-132K. Each of the consumers may browse and/or order various items from the merchants 122A-122N under various contexts. These contexts may include, for example, delivery locations, selected delivery methods, previous dealings with the merchants 122A-122N, and other consumer-related contexts.

The service provider 100 may configure the electronic marketplace 110 to facilitate various transactions between any of the merchants 120 and any of the consumers 130. A transaction involving an item may include searching for, browsing, obtaining, purchasing, providing, delivering, returning the item, and/or other item-related transactions. Further, the electronic marketplace 110 may allow any of the consumers 130 to rate a transaction that the consumer may be involved in. The rating may include providing consumer reviews in the form of, for example, feedback describing various aspects of the transaction. For instance, a consumer review may describe contexts, conditions, and actions associated with a merchant, an item, a delivery method, and/or other aspects of a transaction. In typical cases, a consumer review may include a short a short description that may not exceed a few sentences. In other words, the consumer review may be data of limited size.

Further, the service provider 100 may configure the auto-categorization service 112 to auto-categorize the consumer reviews. Various techniques may be used to auto-categorize the reviews including, for example, machine learning, pattern recognition, word matching, and other techniques. However, because the consumer reviews may be data of limited size, these techniques may yield to good but not necessarily accurate results. Further, because the consumer reviews may be written in different languages, the applied techniques may need to be adjusted based on these languages. Instead, the techniques described herein may improve the accuracy of the auto-categorization, while also the achieved accuracy level may be independent of the underlying language of the consumer reviews.

More particularly, the auto-categorization service 112 may operate on groups of consumer reviews to derive key phrases, where each key phrase may be associated with a group and may reflect the consumer reviews in that group. As illustrated in FIG. 1, each group may include a number of consumer reviews 116 and may be associated with a category identifier 114 and a key phrase 118. The category identifier 114 may be a predefined label that the service provider 100 may identify to define a category. For example, the service provider 100 may predefine categories for consumer reviews related to merchants, items, deliveries, consumer experience, and/or other categories. The consumer reviews 116 may include existing consumer reviews retrieved from the electronic marketplace 110. The existing consumer reviews may be pre-analyzed and categorized, manually or using a certain automated process, into corresponding groups with the proper category identifiers 114. In other words, the consumer reviews 116 may be a training data set usable by the auto-categorization service 112 to generate the key phrases 118. The key phrases 118 may include combinations of words derived from words found in the consumer reviews 116. Each key phrase 118 may be a relevant phrase usable for matching and categorizing t uncategorized consumer reviews in a group or a category. As illustrated in FIG. 1, there may be “M” groups (where M is an integer larger than one) comprising consumer reviews (shown in FIG. 1 as consumer reviews 116A-116M) and associated with category identifiers and key phrases (shown in FIG. 1 as category identifiers 114A-114M and key phrases 118A-118M, respectively). The size (e.g., the number) of consumer reviews 116 can vary between the groups. Similarly, the category identifiers 114 and the key phrases 118 may be unique to each group. Techniques for how a group can be configured and how the category identifiers 114, consumer reviews 116, and key phrases 118 may be determined and used are further described in the next figures.

The auto-categorization service 112 may use the key phrases to categorize uncategorized consumer reviews. Uncategorized consumer reviews may be any review not belonging to a group yet. An example of uncategorized consumer reviews may include a new review 134 received from one of the consumers 130 such as a review submitted at the electronic marketplace 110 after when the key phrases 118 may have been generated. Another example of an uncategorized consumer reviews may include existing consumer reviews that may have not been considered by the auto-categorization service 112 when generating the key phrases 118. In contrast, a categorized consumer review may be a consumer review that the auto-categorization service 112 may have associated with a group. Associating a consumer review with a group may include adding the consumer review to the group, adding a label to the consumer review based on a category identifier of that group, and/or other types of associations. To categorize an uncategorized consumer review such as new review 134, the auto-categorization service 112 may match the uncategorized consumer review to one or more of the key phrases 118. Based on the matching, the auto-categorization service 112 may associate the uncategorized review with one or more groups corresponding to the one or more matched key phrases 118.

Furthermore, the auto-categorization service 112 may service requests related to consumer reviews based on various rules. For example, the auto-categorization service 112 may receive a request from one of the merchants 120 for an action to be performed on a consumer review. As illustrated in FIG. 1, a merchant may, for example, request 124 a removal of the new review 134. In turn, if the new review has not already been categorized, the auto-categorization service 112 may automatically categorize the new review in one of the groups and may look up an applicable rule. Generally, the rule may be predefined by the service provider 100 and may specify what action may be performed on the new review 134 based on various parameters. Some of the parameters may depend on the key phrases 118. For example, the rule may specify a different action based on the key phrase that the new review 134 may be matched to (e.g., to what category or group the new review 134 may belong to). Other parameters may depend on the merchant. For example, the rule may specify a different action based on an identifier of the merchant (e.g., a merchant account). Various actions may be available, such as removing, deleting, adding, storing, publishing, un-publishing, rendering the review anonymous, associating or dissociating the review with the merchant, an item, a delivery method, or a consumer experience, and/or other types of actions. In other words, the rule may be predefined such that an action may be performed based on who that merchant may be and what group(s) the new review 134 may belong to. As such, if the merchant asks to remove a consumer review about the merchant, the auto-categorization service 112 may deny the request 124 because the consumer review may be relevant to the merchant and, thus, may be proper to keep within the context of the electronic marketplace 112. Similarly, if the merchant asks to remove a consumer review about another merchant, the auto-categorization service 112 may likewise deny the request 124. However, if the merchant asks to remove a consumer review incorrectly associated with the merchant, the auto-categorization service 112 may grant the request 124 and may enable removal of the consumer review.

Hence, by implementing the auto-categorization service 112, the service provider 100 may enhance the consumer's and merchant's experience. More particularly, the service provider 100 may rely on the auto-categorization service 112 to auto-categorize a large number of consumer reviews accurately. Further, the service provider 100 may enable a merchant to interact with the auto-categorization service 112 to request removal of consumer reviews. The auto-categorization service 112 may correct situations where a consumer reviews may be incorrectly associated with the merchant.

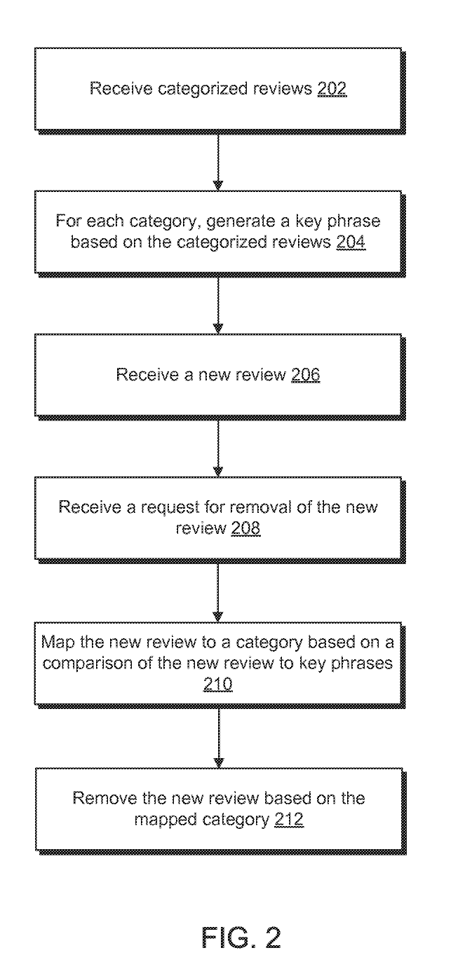

Turning to FIG. 2, that figure illustrates an example flow for auto-categorizing data and performing actions on categorized data. For example, an auto-categorization service of a service provider, such as the auto-categorization service 112 of FIG. 1, may implement the flow of FIG. 2 to auto-categorize consumer reviews in various categories, where each category may represent a group of consumer reviews and may be associated with a number of key phrases. Further, the auto-categorization service may implement the flow of FIG. 2, to perform various actions (e.g., remove, publish) on the consumer reviews based on the corresponding categories.

Although the auto-categorization service is illustrated as performing the operations of the flow, various other computing components may be configured to perform some or all of the operations and other components or combination of components can be used and should be apparent to those skilled in the art. Further, the example flow may be embodied in, and fully or partially automated by, code modules executed by one or more processor devices of the service provider. The code modules may be stored on any type of non-transitory computer-readable medium or computer storage device, such as hard drives, solid state memory, optical disc or other non-transitory medium. The results of the operations may be stored, persistently or otherwise, in any type of non-transitory computer storage such as, e.g., volatile or non-volatile storage. Also, while the flows are illustrated in a particular order, it should be understood that no particular order is necessary and that one or more operations or parts of the flows may be omitted, skipped, or reordered. Additionally, one of ordinary skill in the art will appreciate that computing devices of uses, such as those of merchants and consumers, may perform corresponding operations to provide information and allow interaction between the auto-categorization service and the users.

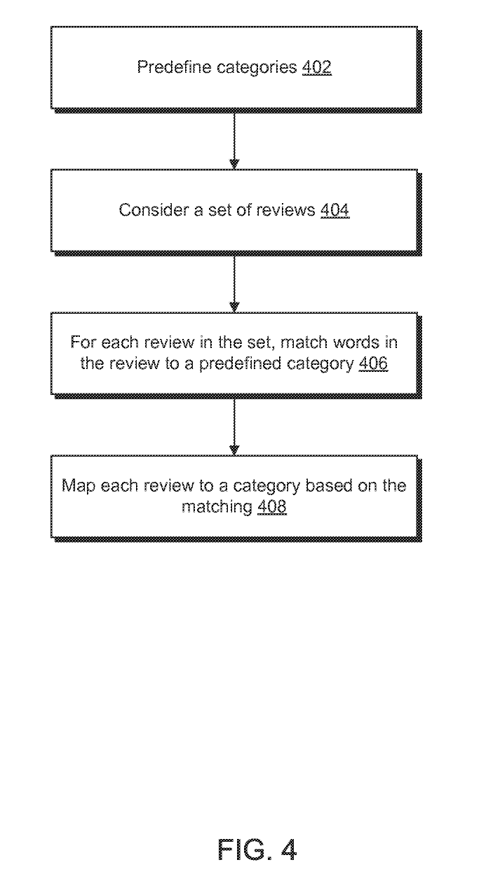

The example flow of FIG. 2 may start at operation 202, where the auto-categorization service may receive categorized reviews, such as pre-categorized consumer reviews. For example, the auto-categorization service may consider groups of existing consumer reviews that may already have been categorized in categories but for which key phrases may not have been generated yet. FIG. 4 illustrates an example flow for pre-categorizing reviews and may be embodied at operation 202.

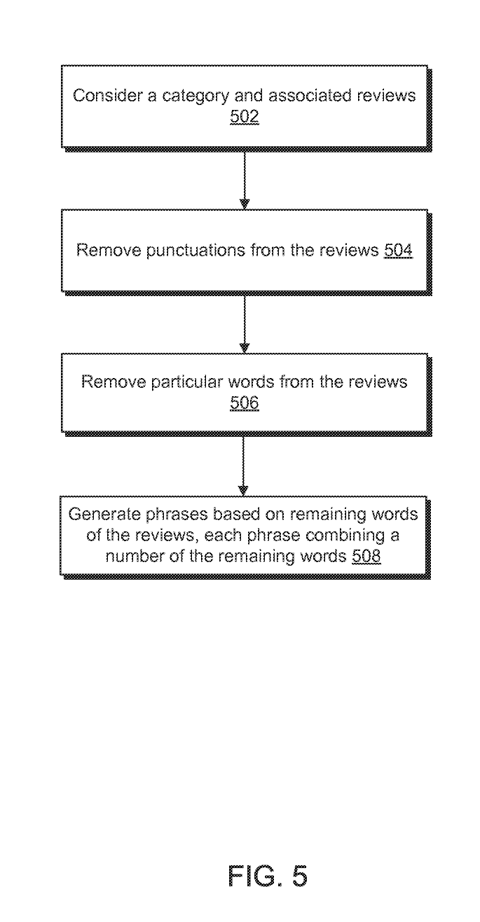

At operation 204, the auto-categorization service may generate, for each category, a number of key phrases based on the categorized reviews. Briefly, a key phrase of a category may be generated based on a relevancy of the key phrase for that category in comparison to relevancies of the key phrase for other categories. To do so, the auto-categorization service may generate, for a category, potential phrases based on words derived from the consumer reviews in the category, and may measure the frequencies of use of each potential phrase in the category and in the other categories. Based on these frequencies, the auto-categorization service may determine the relevancy of each potential phrase per category. For a particular category, the auto-categorization service may set the potential phrase with the highest relevancy as the key phrase for that particular category. The auto-categorization service may also set other potential phrases as key phrases for that particular category based on the corresponding relevancies. FIGS. 5-7 illustrate example flows and potential phrases for determining key phrases and may be embodied at operation 204.

At operation 206, the auto-categorization service may receive a new review. In an example, the auto-categorization service may consider a consumer review newly submitted by a consumer. In another example, the auto-categorization service may consider an uncategorized consumer review. The new review may be published at an electronic marketplace associated with the auto-categorization service and may be available for viewing by multiple users, including consumers and merchants. In response to receiving the new review, the auto-categorization service may proceed to operation 210 to auto-categorize the new review. Alternatively, the auto-categorization service may wait for a request from a user, such as a merchant or the service provider, before proceeding to operation 210.

At operation 208, the auto-categorization may receive a request for removal of the new review. The request may be submitted by various users, including the service provider, a merchant, or even a consumer. The request may also not be limited for removal but may identify various actions available on the new review such as storing, associating, disassociating, and/or other actions.

At operation 210, the auto-categorization service may map the new review to a category based on a comparison of the new review to key phrases. In an example, the auto-categorization service may categorize the new review in one or more of the categories. To do so, the auto-categorization service may match the new review to one or more key phrases and, based on the matching, may associate the new review with one or more categories corresponding to the matched one or more key phrases.

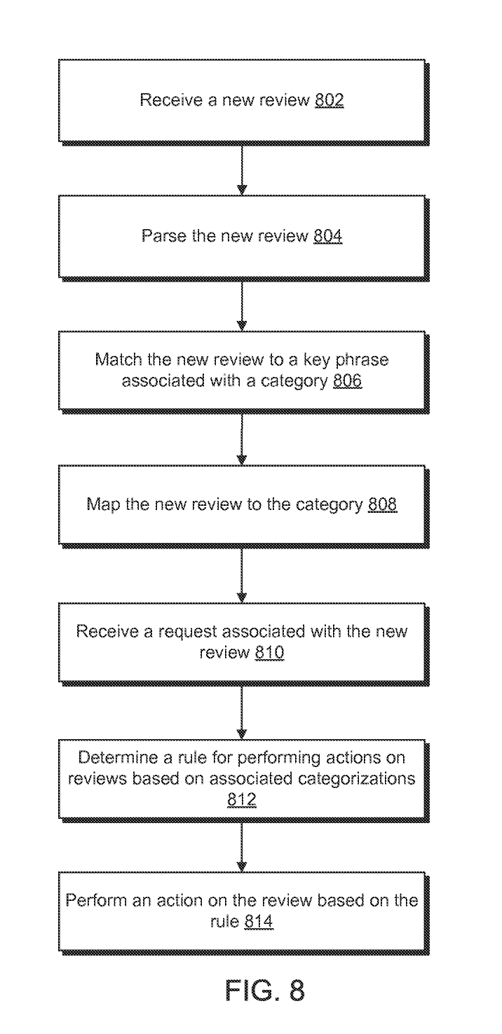

At operation 212, the auto-categorization service may remove the new review based on the mapped one or more categories. To do so, the auto-categorization service may use a set of rules defining what actions may be performed based on various parameters. The rules may be defined by, for example, the service provider. In an example, the rules may specify that a review may be removed if the request for removal is received from a merchant and if the review is not associated with the merchant. As such, the auto-categorization may determine the parameters (e.g., by identifying the requestor and the one or more categories of the review) and may enable the action specified by the rules. For example, if the new review was published in association with a merchant but was auto-categorized as belonging to a non-merchant category (e.g., belonging to a delivery issue category), and if the requestor was the merchant, the auto-categorization service may grant the request and remove the new review. Removing the new review may include deleting the new review from storage, un-publishing the new review, or re-associating the new review with a proper category (e.g., based on the auto-categorization) and re-publishing the new review with the proper association (e.g., instead of listing the new review as related to the merchant, the auto-categorization service may re-list the new review at the electronic marketplace as being associated with a delivery issue). FIG. 8 illustrates an example flow for processing a new review and may be embodied at operations 208-212.

Hence, the example flow of FIG. 2 may allow the service provider to automate the process of categorizing reviews and performing actions on the categorized reviews. As the number of reviews increases, and as the number of items, merchants, and consumers of the electronic marketplace increases, by implementing the example flow of FIG. 2, the service provider may ensure that the reviews may be processed not only automatically, but also accurately.

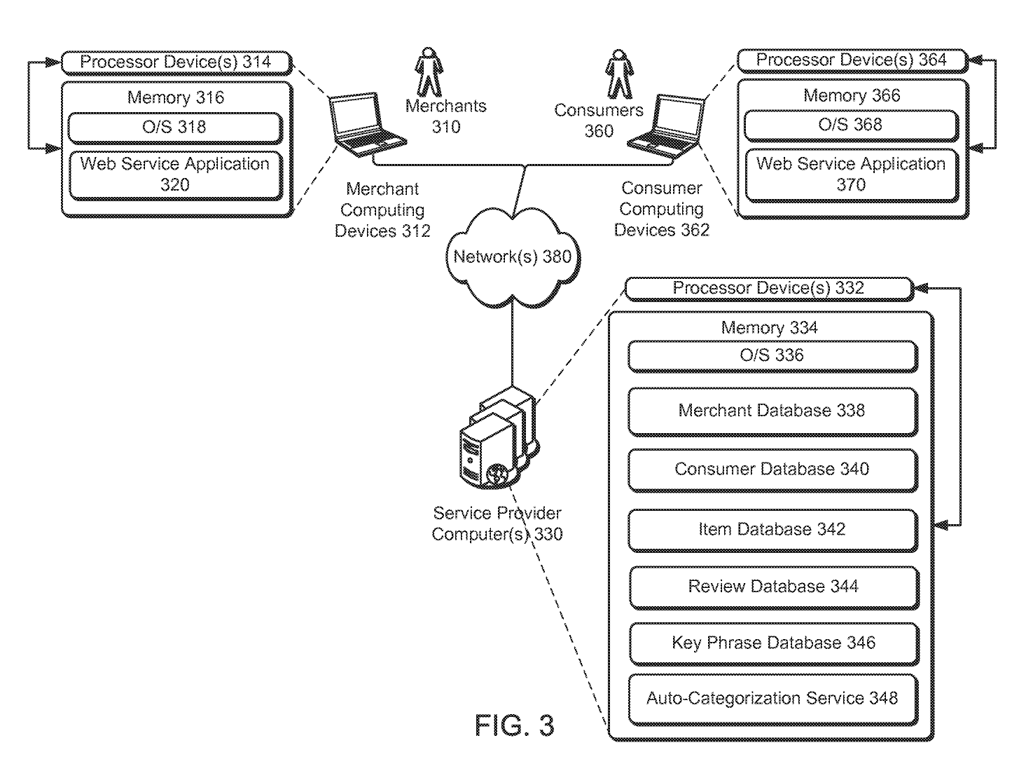

Turning to FIG. 3, that figure illustrates an example end-to-end computing environment for auto-categorizing and performing actions on data, such as consumer reviews. In this example, a service provider may implement an auto-categorization service, such as the auto-categorization service 112 of FIG. 1, part of an electronic marketplace available to users, such as the merchants 120 and the consumers 130 of FIG. 1.

In a basic configuration, merchants 310 may utilize merchant computing devices 312 to access local applications, a web service application 320, merchant accounts accessible through the web service application 320, or a web site or any other network-based resources via one or more networks 380. In some aspects, the web service application 320, the web site, or the merchant accounts may be hosted, managed, or otherwise provided by one or more computing resources of the service provider, such as by utilizing one or more service provider computers 330.

The merchants 310 may use the local applications or the web service application 320 to interact with the network-based resources of the service provider. These transactions may include, for example, offering items for sale, supporting transactions with consumers, and requesting actions to be performed on consumer reviews.

In some examples, the merchant computing devices 312 may be any type of computing devices such as, but not limited to, a mobile phone, a smart phone, a personal digital assistant (PDA), a laptop computer, a thin-client device, a tablet PC, etc. In one illustrative configuration, the merchant computing devices 312 may contain communications connection(s) that allow merchant computing devices 312 to communicate with a stored database, another computing device or server, merchant terminals, or other devices on the networks 380. The merchant computing devices 312 may also include input/output (I/O) device(s) or ports, such as for enabling connection with a keyboard, a mouse, a pen, a voice input device, a touch input device, a display, speakers, a printer, etc.

The merchant computing devices 312 may also include at least one or more processing units (or processor device(s)) 314 and one memory 316. The processor device(s) 314 may be implemented as appropriate in hardware, computer-executable instructions, firmware, or combinations thereof. Computer-executable instruction or firmware implementations of the processor device(s) 314 may include computer-executable or machine-executable instructions written in any suitable programming language to perform the various functions described.

The memory 316 may store program instructions that are loadable and executable on the processor device(s) 314, as well as data generated during the execution of these programs. Depending on the configuration and type of merchant the computing devices 312, the memory 316 may be volatile (such as random access memory (RAM)) or non-volatile (such as read-only memory (ROM), flash memory, etc.). The merchant computing devices 312 may also include additional storage, which may include removable storage or non-removable storage. The additional storage may include, but is not limited to, magnetic storage, optical disks, or tape storage. The disk drives and their associated computer-readable media may provide non-volatile storage of computer-readable instructions, data structures, program modules, and other data for the computing devices. In some implementations, the memory 316 may include multiple different types of memory, such as static random access memory (SRAM), dynamic random access memory (DRAM), or ROM.

Turning to the contents of the memory 316 in more detail, the memory may include an operating system (O/S) 318 and the one or more application programs or services for implementing the features disclosed herein including the web service application 320. In some examples, the merchant computing devices 312 may be in communication with the service provider computers 330 via the networks 380, or via other network connections. The networks 380 may include any one or a combination of many different types of networks, such as cable networks, the Internet, wireless networks, cellular networks, and other private or public networks. While the illustrated example represents the merchants 310 accessing the web service application 320 over the networks 380, the described techniques may equally apply in instances where the merchants 310 interact with the service provider computers 330 via the merchant computing devices 312 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer systems, etc.).

Similarly, consumers 360 may utilize consumer computing devices 362 to access local applications, a web service application 370, consumer accounts accessible through the web service application 370, or a web site or any other network-based resources via the networks 380. In some aspects, the web service application 370, the web site, or the user accounts may be hosted, managed, or otherwise provided by the service provider computers 330 and may be similar to the web service application 320, the web site accessed by the computing device 312, or the merchant accounts, respectively.

The consumers 360 may use the local applications or the web service application 370 to conduct transactions with the network-based resources of the service provider. These transactions may include, for example, searching for and purchasing items from the merchants 310 and providing consumer reviews for commenting on various aspects of the transactions.

In some examples, the consumer computing devices 362 may be configured similarly to the merchant computing devices 312 and may include at least one or more processing units (or processor device(s)) 364 and one memory 366. The processor device(s) 364 may be implemented as appropriate in hardware, computer-executable instructions, firmware, or combinations thereof similarly to the processor device(s) 314. Likewise, the memory 366 may also be configured similarly to the memory 316 and may store program instructions that are loadable and executable on the processor device(s) 364, as well as data generated during the execution of these programs. For example, the memory 366 may include an operating system (O/S) 368 and the one or more application programs or services for implementing the features disclosed herein including the web service application 370.

As described briefly above, the web service applications 320 and 370 may allow the merchants 310 and consumers 360, respectively, to interact with the service provider computers 330 to conduct transactions involving items. The service provider computers 330, perhaps arranged in a cluster of servers or as a server farm, may host the web service applications 320 and 370. These servers may be configured to host a web site (or combination of web sites) viewable via the computing devices 312 and 362. Other server architectures may also be used to host the web service applications 320 and 370. The web service applications 320 and 370 may be capable of handling requests from many merchants 310 and consumers 360, respectively, and serving, in response, various interfaces that can be rendered at the computing devices 312 and 362 such as, but not limited to, a web site. The web service applications 320 and 370 can interact with any type of web site that supports interaction, social networking sites, electronic retailers, informational sites, blog sites, search engine sites, news and entertainment sites, and so forth. As discussed above, the described techniques can similarly be implemented outside of the web service applications 320 and 370, such as with other applications running on the computing devices 312 and 362, respectively.

The service provider computers 330 may, in some examples, provide network-based resources such as, but not limited to, applications for purchase or download, web sites, web hosting, client entities, data storage, data access, management, virtualization, etc. The service provider computers 330 may also be operable to provide web hosting, computer application development, or implementation platforms, or combinations of the foregoing to the merchants 310 and consumers 360.

The service provider computers 330 may be any type of computing device such as, but not limited to, a mobile phone, a smart phone, a personal digital assistant (PDA), a laptop computer, a desktop computer, a server computer, a thin-client device, a tablet PC, etc. The service provider computers 330 may also contain communications connection(s) that allow service provider computers 330 to communicate with a stored database, other computing devices or server, merchant terminals, or other devices on the network 380. The service provider computers 330 may also include input/output (I/O) device(s) or ports, such as for enabling connection with a keyboard, a mouse, a pen, a voice input device, a touch input device, a display, speakers, a printer, etc.

Additionally, in some embodiments, the service provider computers 330 may be executed by one more virtual machines implemented in a hosted computing environment. The hosted computing environment may include one or more rapidly provisioned and released network-based resources, which network-based resources may include computing, networking, or storage devices. A hosted computing environment may also be referred to as a cloud computing environment. In some examples, the service provider computers 330 may be in communication with the computing devices 312 and 362 via the networks 380, or via other network connections. The service provider computers 330 may include one or more servers, perhaps arranged in a cluster, or as individual servers not associated with one another.

In one illustrative configuration, the service provider computers 330 may include at least one or more processing units (or processor devices(s)) 332 and one memory 334. The processor device(s) 332 may be implemented as appropriate in hardware, computer-executable instructions, firmware, or combinations thereof. Computer-executable instruction or firmware implementations of the processor device(s) 332 may include computer-executable or machine-executable instructions written in any suitable programming language to perform the various functions described.

The memory 334 may store program instructions that are loadable and executable on the processor device(s) 332, as well as data generated during the execution of these programs. Depending on the configuration and type of the service provider computers 330, the memory 334 may be volatile (such as random access memory (RAM)) or non-volatile (such as read-only memory (ROM), flash memory, etc.). The service provider computers 330 may also include additional removable storage or non-removable storage including, but not limited to, magnetic storage, optical disks, or tape storage. The disk drives and their associated computer-readable media may provide non-volatile storage of computer-readable instructions, data structures, program modules, and other data for the computing devices. In some implementations, the memory 334 may include multiple different types of memory, such as static random access memory (SRAM), dynamic random access memory (DRAM), or ROM.

Additionally, the computer storage media described herein may include computer-readable communication media such as computer-readable instructions, program modules, or other data transmitted within a data signal, such as a carrier wave, or other transmission. Such a transmitted signal may take any of a variety of forms including, but not limited to, electromagnetic, optical, or any combination thereof. However, as used herein, computer-readable media does not include computer-readable communication media.

Turning to the contents of the memory 334 in more detail, the memory may include an operating system (O/S) 336, a merchant database 338 for storing information about the merchants 310, a consumer database 340 for storing information about the consumers 360, an item database 342 for storing information about items offered by the merchants 310, a review database 344 for storing information about reviews submitted by the consumers 360 and other users (e.g., reviews submitted by the merchants 310), a key phrase database 346 for storing information about key phrases representative of categories of reviews, and an auto-categorization service 348.

The service provider may configure the auto-categorization service 348 to auto-categorize reviews and perform actions on categorized reviews, similarly to the auto-categorization service 112 of FIG. 1. The auto-categorization service 348 may interface with any of the databases 338-346 for providing these functions. Although FIG. 3 illustrates the databases 338-346 as stored in the memory 334, these databases or information from these databases may be additionally or alternatively stored at a storage device remotely accessible to the service provider computers 330. Configurations and operations of the auto-categorization service 348 are further described in greater detail below with reference to at least FIGS. 4-8.

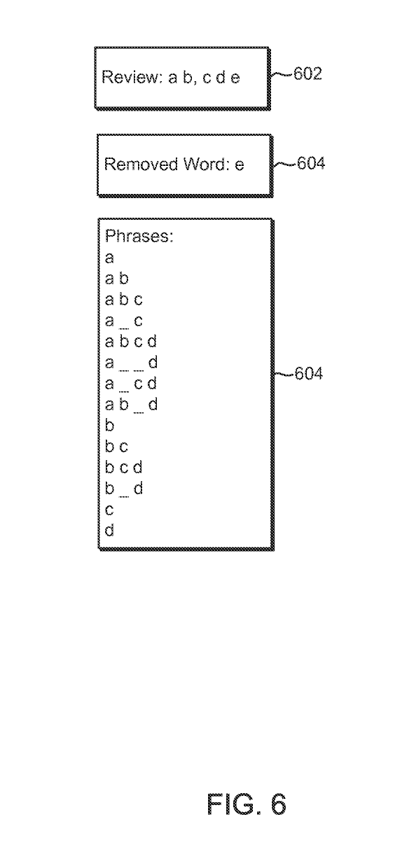

More particularly, FIGS. 4-5 and 7-8 illustrate example flows that can be implemented for auto-categorizing and performing actions on data as described above in FIGS. 1-3. In comparison, FIG. 6 illustrates an example of potential strings of elements derived from data, such as potential phrases derived from consumer reviews. In the interest of clarity of explanation, an auto-categorization service, such as the auto-categorization service 348 of FIG. 3, is described in FIGS. 4-5 and 7-8 as performing the flows. However, various components of the service provider computers 330 may be configured to perform some or all of the operations and other components or combination of components can be used and should be apparent to those skilled in the art.

Further, the example flows of FIGS. 4-5 and 7-8 may be embodied in, and fully or partially automated by, code modules executed by one or more processor devices of the service provider computers 330. The code modules may be stored on any type of non-transitory computer-readable medium or computer storage device, such as hard drives, solid state memory, optical disc or other non-transitory medium. The results of the operations may be stored, persistently or otherwise, in any type of non-transitory computer storage such as, e.g., volatile or non-volatile storage. Also, while the flows are illustrated in a particular order, it should be understood that no particular order is necessary and that one or more operations or parts of the flows may be omitted, skipped, or reordered. Additionally, one of ordinary skill in the art will appreciate that a computing device of a user, such as the computing devices 312 and 362 of the merchants 310 and consumers 360, may perform corresponding operations to provide information to and allow interaction with the user.

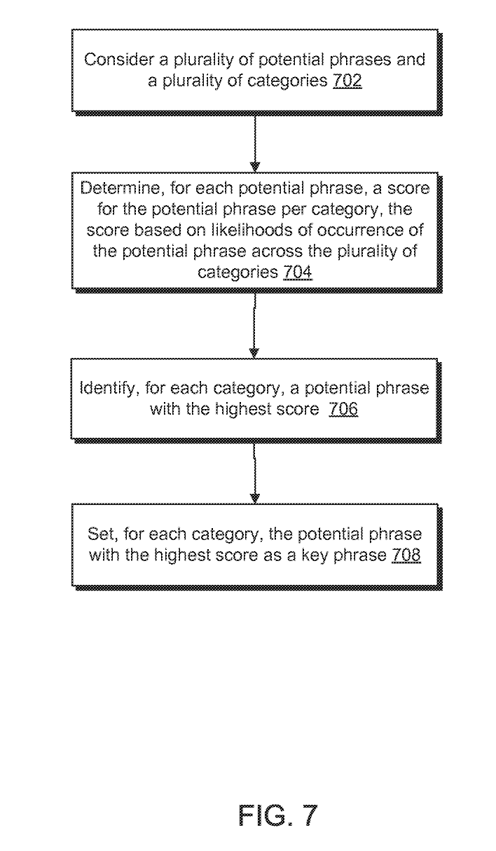

FIG. 4 illustrates an example flow for pre-categorizing data in groups and FIG. 5 illustrates an example flow for generating potential strings of elements based on pre-categorized data. In comparison, FIG. 7 illustrates an example flow for generating a most relevant string of elements per group of categorized data. The input to the example flow of FIG. 7 may be the potential strings of elements outputted from the example flow of FIG. 5. Further, FIG. 8 illustrates an example flow that the auto-categorization service may implement for performing actions on uncategorized data. The example flow of FIG. 8 may use most relevant strings of elements determined from the example flow of FIG. 7 to map the uncategorized data to one or more of groups available from the example flow of FIG. 4. In the interest of clarity of explanation, consumer reviews, potential phrases, and key phrases are illustrated in FIG. 4-8. However, other types of data may be similarly processed.

Turning to FIG. 4, that figure illustrates an example flow for pre-categorizing consumer reviews in groups, where each group may be associated with a category. Generally, the example flow of FIG. 4 may be implemented to define categories of consumer reviews usable to train the auto-categorization service for deriving key phrases for the categories. In other words, prior to generating key phrases, the auto-categorization service may perform the example flow of FIG. 4 to receive groups of consumer reviews already pre-categorized in categories. These categories may be defined by various users, such as by a service provider implementing the auto-categorization service.

The example flow of FIG. 4 may start at operation 402, where the auto-categorization service may predefine categories. For example, the auto-categorization service may provide an interface to the service provider for defining categories such as merchant, item, delivery issue, consumer experience, and/or other categories.

At operation 404, the auto-categorization service may consider a set of reviews. For example, the auto-categorization service may retrieve a statistically large enough number, perhaps thousands or more, of existing consumer reviews. The retrieved consumer reviews may be short descriptions that may not have been categorized yet. But, when processed through the remaining operations of the example flow of FIG. 4, the retrieved consumer reviews would be mapped to one or more of the categories based on the content of the descriptions.

At operation 406, the auto-categorization service may match each considered consumer review to one or more of the categories. Various techniques may be used including machine learning algorithms, pattern matching algorithms, clustering algorithms, word matching algorithms, and/or other techniques. As such, the auto-categorization service may determine which category or categories each considered consumer review may belong to.

At operation 408, the auto-categorization service may map each considered review to one or more of the categories based on the matching of operation 406. Mapping may include adding a consumer review matched with a category to a group of consumer reviews corresponding to that category. Other types of mapping may also be used such as, for example, labeling the consumer review with a description indicative of the matched category.

Hence, by implementing the example flow of FIG. 4, an automated process may be available for pre-categorizing consumer reviews in groups of predefined categories. However, other processes, perhaps less automated, may also be used. For example, the service provider may manually review and categorize existing consumer reviews. In another example, the auto-categorization service may provide an interface to consumers, such as trusted consumers, to input consumer reviews. The interface may allow a consumer to choose a pre-defined category in association with inputting a consumer review at the interface.

Turning to FIG. 5, that figure illustrates an example flow for generating potential phrases based on groups of categorized consumer reviews. The auto-categorization service may use the groups of categorized consumer reviews from the example flow of FIG. 4 to generate potential phrases associated with the groups or categories.

The example flow of FIG. 5 may start at operation 502, where the auto-categorization service may consider a category and associated consumer reviews. For example, for each of the available groups of categorized consumer reviews, the auto-categorization service may determine the consumer reviews in that group. This may include parsing the consumer reviews to determine the words and the punctuations in each consumer review.

At operation 504, the auto-categorization service may remove punctuations from the consumer reviews. For example, the auto-categorization service may turn each consumer review into a string of words that does not contain punctuation. The string of words may preserve locations of the word as found in the consumer review. To illustrate, the auto-categorization service may turn a consumer review of “I bought the item, but have not received it!!!” to [(I, 1), (bought, 2), (the, 3), (item, 4), (but, 5), (have, 6), (not, 7), (received, 8), (it, 9)] where a parenthesis ( ) may indicate a word and a location of the word in the consumer review. Of course other types of strings for removing punctuations and preserving locations of words may be used. For example, the illustrated consumer review may be expressed alternatively as [I bought the item but have not received it].

At operation 506, the auto-categorization service may remove particular words from the consumer reviews. Various types of words may be removed including, for example, starting point words, stop words, predefined words, words occurring a certain frequency, and/or other types of words. These types of words may generally not carry much information to affect the accuracy of generating and using key phrases and, thus, may not be important. To simplify the computation and avoid an exhaustive generation of phrases using all available words, the auto-categorization service may remove unimportant words. A starting point word may be a word that a consumer review or a sentence within the consumer review may start with. A stop word may be a word occurring at an edge of a sentence, such as at the beginning, the end, or following a punctuation break. A Predefined word may be a word that the service provider may input by way of an interface provided by the auto-categorization service. For example, the service provider may determine that pronouns like “I, my, you, yours,” and other pronouns may be unimportant and may flag to remove such words from the flow. Similarly, words occurring at a certain frequency, such as below a certain threshold, may be removed. For example, a word appearing only once across consumer reviews in a group may be an unimportant word.

In addition to removing particular words, the auto-categorization service may replace words with equivalents. An example of equivalents includes synonyms. For instance, the words “get” and “obtain” may be replaced with the word “receive.” Other examples of equivalents include roots of words, variations of words, and/or other equivalents. For instance, the words “received” and “receiving” may be replaced with “receive.” This replacing may alleviate the computation of the potential phrases by minimizing the number of words that can be combined and, thus, avoiding an exhaustive generation of phrases that may have similar relevancies. To illustrate, the auto-categorization service may render the example consumer review shown at operation 504 as [(bought, 2), (item, 4), (received, 8)] or [_buy_item_receive_], where a “_” may indicate a removed word.

At operation 508, the auto-categorization service may generate phrases based on remaining words of the consumer reviews, where each phrase may combine a number of the remaining words. The phrases may represent potential phrases that may be further analyzed for relevancy to determine key phrases as described in the example flow of FIG. 7. Various techniques may be available for generating the potential phrases. In on example, a number of phrases may be generated from each consumer review. Said differently, the auto-categorization service may generate combinations of remaining words found in a consumer review. To illustrate and continuing with the above example consumer review, the auto-categorization service may generate a number of potential phrases such as [(bought, 2)], [(item, 4)], [(received, 8)], [(bought, 2), (item, 4)], [(bought, 2), (received, 8)], [(item, 4), (received, 8)], and/or other combinations. As explained herein above, these combinations may also be expressed differently, such as [_buy_], [_receive_] and so on. In another example, a number of phrases may be generated from all of the consumer reviews. Said differently, the auto-categorization service may list all of the remaining words found across the consumer reviews and may combine words from the list to generate the phrases.

Furthermore, the auto-categorization service may set a length for each generated phrase to a range, such as a minimum number and/or a maximum number of words to be used in a phrase. By limiting the lengths of the phrases, the auto-categorization service may reduce the computation by not considering combinations that may deviate from the length. For example, the auto-categorization service may set the length to be between three and six words per phrase, or any other number. Combinations shorter than three words or longer than six words may be eliminated. Various techniques may be used to set the length. In one example, the service provider may predefine the length by way of an interface provided by the auto-categorization service. In another example, the auto-categorization service may compute an average length of the consumer reviews and an associated standard deviation and may set a range of acceptable lengths around the average and deviation. For instance, the minimum number may be equal to the average length minus the deviation, while the maximum number may be equal to the average length plus the deviation.

Although the example flow of FIG. 5 illustrates generating phrases per group of categorized reviews, such phrases can also be generated across the various groups. For example, instead of considering one group at a time, the auto-categorization service may consider multiple groups at once. Said differently, the auto-categorization service may combine words from the multiple groups to generate potential phrases. In an example, the considered groups may be groups of categories that may be related to some extent. For example, categories of “merchant” and “consumer experience” may be considered together because merchants may impact the consumer experience.

Hence, by implementing the example flow of FIG. 5, an automated process may be available for generating phrases. As explained herein above, the auto-categorization service may set these phrases as potential phrases for evaluation to determine key phrases for the groups of categorized reviews as illustrated in the example flow of FIG. 7.

Turning to FIG. 6, that figure illustrates a string of readable objects from which combinations of readable objects may be generated. For example, the auto-categorization service may generate phrases 604 out of a consumer review 602. As illustrated, the consumer review 602 may contain “a b, c d e” where each of “a,” “b,” “c,” “d”, and “e” may represent a word and where “,” may represent a punctuation. When operation 504 of FIG. 5 is performed, the auto-categorization service may remove the “,” punctuation. Similarly, when operation 506 of FIG. 5 is performed, the auto-categorization service may remove the “e” word 604 because the “e” may be an unimportant word such as, for example, a stop word or a word from a predefined set.

The phrases 604 may represent strings of words that may combine remaining words from the consumer review 602. Said differently, each phrase of the phrases 604 may represent a combination of one or more remaining words found in the consumer review 602. Example phrases may include “a,” “a b,” “a b c,” “a_c” and so on. As illustrated the order of the words in the consumer review 602 may be observed in the phrases 604. For example a “_” may be used to indicate a skipped word such that the words before and after the skipped one may be listed in the proper order. Similarly, a phrase may not combine words in an incorrect order (e.g., a combination of “b a” may not be generated). The auto-categorization service may observe the order of the words in the consumer review 602 for multiple reasons. For example, changing the order may change the context for using the words in the consumer review 602 and may, thus, affect the accuracy of generating key phrases. Further, generating combination with unobserved orders may increase the required computation to derive the key phrases without necessarily improving the accuracy.

Turning to FIG. 7, that figure illustrates an example flow for generating key phrases based on associated relevancies. A relevancy may reflect how relevant a phrase may be for a category or a group of categorized consumer reviews in comparison to other categories or groups. In an example, the auto-categorization service may express a relevancy of a phrase relative to a group as a function of how frequently the phrase occurs in the group in comparison to other groups. In other words, the auto-categorization service may express the relevancy as a function of frequencies of occurrence or probabilities of use as further explained herein below.

The example flow of FIG. 7 may start at operation 702, where the auto-categorization service may consider a plurality of potential phrases and a plurality of categories. For example, for each group of categorized reviews, there may be a number of phrases as described in FIGS. 4 and 5. The auto-categorization service may set these phrases as the potential phrases associated with the respective categories or groups.

At operation 704, the auto-categorization service may determine a score for each potential phrase per category. The score may indicate how relevant that potential phrase may be for that category. As further described herein next, the score may be based on likelihoods of occurrence of the potential phrase across the plurality of categories. For example, the auto-categorization service may consider a potential phrase and may determine how frequently that potential phrase may be used in every category. For each category, the frequency of using the potential phrase may be expressed as a total number of times that the potential phrase occurs in that category. That number of times may be normalized by the total number of consumer reviews in the category to derive a probability of use for the potential phrase in the category. This calculation may be repeated for each potential phrase across each category.

The number of times for a potential phrase may be derived by word matching the potential phrase with words in the consumer reviews. Various word matching techniques may be employed, including techniques that may use equivalent word matching and weights. In an example, the match may need to be exact (e.g., the number of times may be increased only if every word in the potential phrase is found in a consumer review). In another example, the match need not be exact, but may use equivalents. In a further example, not every word in the potential phrase may need to be matched (exactly or equivalently). Instead, the number of times may be increased based on a weight of the match. For instance, if the potential phrase includes five words and only two words matched a consumer review, the number of times may be increased by a factor of 0.4 (e.g., two divided by five).

Once the total numbers of times and/or probabilities of use are determined, the auto-categorization service may have a set of metrics to determine the relevancy of each potential phrase per category. A metric may include a total number of times (e.g., a frequency) and/or a probability of use. Each potential phrase may be associated with a metric per category and, thus, may be associated with a plurality of metrics across the categories. To determine relevancy of the phrase for a particular category, the auto-categorization service may perform a multi-step comparison. First, the auto-categorization service may compare the metric of the potential phrase for that particular category to metrics of the phrase across the other categories. This first step may allow the auto-categorization service to determine a relative relevancy of the potential phrase for that particular category and to eliminate potential phrases that may relevant to more than one category. The relative relevancy may be expressed as a score that may use the metrics. For example, the score may be set as:

$${score}_{i , l} = {\sum }_{{k = 1}_{k \neq i}}^{n} \frac{{p}_{i , l}}{{p}_{k , l}}$$

where score_{i,l} may be the relative relevance of a potential phraseₗ out of the potential phrases for a categoryᵢ out of “n” categories, where p_{i,l} may be the probability of use of the potential phraseₗ in the categoryᵢ, and where p_{k,l} may be the probability of use of the potential phraseₗ in a remaining categoryₖ out of the “n” categories. To avoid divisions by zero, the various probabilities may be initiated to a small value (e.g., a “0.01” or some other value).

In a second step, the auto-categorization service may compare metrics of potential phrases per category as described in operations 706 and 708. For example, the auto-categorization service may compare the scores of all potential phrases in a particular category. This second step may allow the auto-categorization service to determine which of the potential phrases may be the most relevant potential phrase(s) for that particular group. Although scores and metrics may include quantitative measurements, other types of scores and metrics may also be used. For example, a score may be mapped to a qualitative assessment by applying a threshold (e.g., high, good, acceptable, bad, or other qualitative assessments). To illustrate, a score falling between 90 and 100 on a scale of 100 may be mapped to a “high” score, while a score equal lower than that range may be mapped to a “low” score.

At operation 706, the auto-categorization service may identify, for each category, a potential phase with the highest score. For example, the auto-categorization service may consider potential phrases in a particular category, may compare the relative relevancies of these potential phrases for that particular category, and may determine which of the potential phrases may be the most relevant (e.g., having the highest score).

At operation 708, the auto-categorization service may set, for each category, the potential phrase with the highest score as the key phrase. For example, the auto-categorization may flag, for a particular category, the most relevant potential phrase from operation 706 as the key phrase for that particular group.

To illustrate, consider the example of two potential phrases: [receive item] and [bought merchant], and three categories: merchant, item, and delivery issue. The [receive item] may have a probability of use of 0.1 in the first category, 0.2 in the second category, and 0.8 in the third category. Thus, the score of the [receive item] may be 0.1/0.2+0.1/0.8=0.625 for the first category, 0.2/0.1+0.2/0.8=2.25 for the second category, and 0.8/0.1+0.8/0.2=12 for the third category. Thus, relatively, the [receive item] may be more relevant to the third category than the other two. In comparison, the [bought merchant] may have a probability of use of 0.7 in the first category, 0.3 in the second category, and 0.1 in the third category. Thus, the score of the [bought merchant] may be 0.7/0.3+0.7/0.1=9.33 for the first category, 0.3/0.7+0.3/0.1=3.43 for the second category, and 0.1/0.7+0.1/0.3=0.48 for the third category. Thus, relatively, the [bought merchant] may be more relevant to the first category than the other two. When the two potential phrases are compared in association with the merchant category, the auto-categorization service may set the [bought merchant] as the key phrase for that category. Likewise, when the two potential phrases are compared in association with the delivery issue category, the auto-categorization service may set the [receive item] as the key phrase for that category.

Additionally, the auto-categorization service may use other techniques for determining a key phrase for a particular category, including techniques that may apply thresholds. In an example, the auto-categorization service may set the highest score in a category as a threshold (e.g., this technique would be similar to operation 708). In another example, the auto-categorization service may set a threshold as a predefined score. If a score of a potential phrase for a particular category exceeds that predefined score, the potential phrases may be tagged as a key phrase for that particular category, along with other potential phrases that may similarly exceed the predefined score. In yet another example, a threshold may be related to a range of acceptable scores. The auto-categorization service may set any potential phrase with a score falling within that range as a key phrase. In a further example, a threshold may be a number limiting how many key phrases may be acceptable for a category. For example, for a particular category, the auto-categorization service may set three potential phrases with the top three scores, or some other number or percentage, as the three key phrases for that particular group. These and other thresholds may be defined by various users including, for example, the service provider by way of an interface provided by the auto-categorization service.

Turning to FIG. 8, that figure illustrates an example flow for performing actions on a new review. The new review may be a newly received consumer review or may be an uncategorized consumer review regardless of when received. What actions may be performed may depend on various parameters including what category or categories that consumer review may be categorized in. Other usable parameters may include an identity of a requestor when available. Such a parameter may ensure that actions are performed only if the requestor is properly authorized or permitted. The actions and parameters may be specified in rules as further described herein below.

The example flow of FIG. 8 may start at operation 802, where the auto-categorization service may receive a new review. For example, a consumer may conduct a transaction at an electronic marketplace that may implement the auto-categorization service and may leave, at the electronic marketplace, a review describing aspects of the transaction. The new review may be published at the electronic marketplace. As explained herein above, other types of uncategorized reviews may be received at operation 802.

At operation 804, the auto-categorization service may parse the new review to determine words in that review. At operation 806, the auto-categorization service may match the new review to one or more key phrases associated with one or more categories. For example, the auto-categorization service may word match the parsed words to key phrases of a number of categories using various word matching algorithms such as any of exact, equivalent, and weighted word matching algorithms. The new review may match one or more categories.

At operation 808, the auto-categorization service may map the new review to the one or more categories. For example, the auto-categorization may add the new review to a group represented by a matched key phrase. In another example, the auto-categorization service may flag or label the new review with an identifier of the group or the category associated with the group.

At operation 810, the auto-categorization service may receive a request associated with the new review. For example, the request may ask for an action to be performed on the new review, such as removing the new review from publication at the electronic marketplace, publishing the new review, or some other action. The auto-categorization service may receive the request from a computing device of a user interfacing with the auto-categorization service, such as a merchant, a consumer, the service provider, or another user.

At operation 812, the auto-categorization service may determine a rule for performing actions on reviews based on associated categorizations of the reviews. For example, the auto-categorization service may query a set of rules by identifying the one or more categories of the new review and the requestor. The set of rules may specify what actions may be performed based on these and other parameters. For example, the set of rules may allow a merchant to remove a consumer review that may be improperly associated with the merchant. However, the set of rules may deny the merchant from removing a consumer review that may be properly associated with the merchant.

At operation 814, the auto-categorization service may perform an action based on the rule. For example, the auto-categorization service may determine the proper action as a result to the query and may enable computing resources of the electronic marketplace to perform the action. As such, if the action indicates that the new review should be removed, the auto-categorization service may instruct the computing resources to delete the new review. On the other hand, if the action indicates that the review should not be removed, the auto-categorization service may notify the requestor that the request should be denied.

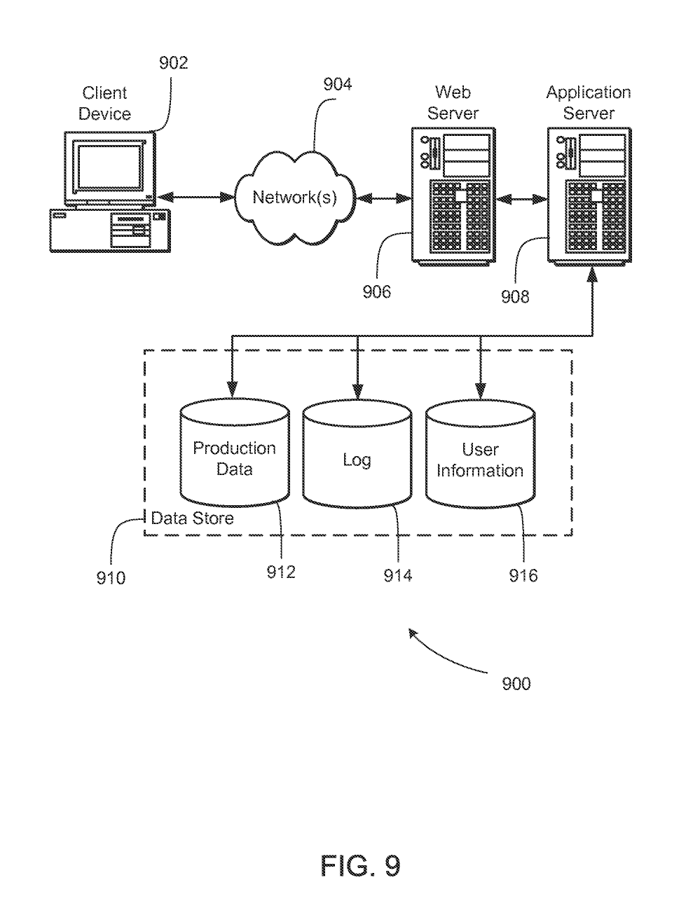

Turning to FIG. 9, that figure illustrates aspects of an example environment 900 capable of implementing the above-described structures and functions. As will be appreciated, although a Web-based environment is used for purposes of explanation, different environments may be used, as appropriate, to implement various embodiments. The environment includes an electronic client device 902, which can include any appropriate device operable to send and receive requests, messages, or information over an appropriate network(s) 904 and convey information back to a user of the device. Examples of such client devices include personal computers, cell phones, handheld messaging devices, laptop computers, set-top boxes, personal data assistants, electronic book readers, or any other computing device. The network(s) 904 can include any appropriate network, including an intranet, the Internet, a cellular network, a local area network or any other such network or combination thereof. Components used for such a system can depend at least in part upon the type of network or environment selected. Protocols and components for communicating via such a network are well known and will not be discussed herein in detail. Communication over the network can be enabled by wired or wireless connections and combinations thereof. In this example, the network includes the Internet, as the environment includes a Web server 906 for receiving requests and serving content in response thereto, although for other networks an alternative device serving a similar purpose could be used as would be apparent to one of ordinary skill in the art.

The illustrative environment includes at least one application server 908 and a data store 99. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing, or retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server provides access control services in cooperation with the data store, and is able to generate content such as text, graphics, audio or video to be transferred to the user, which may be served to the user by the Web server in the form of HTML, XML or another appropriate structured language in this example. The handling of all requests and responses, as well as the delivery of content between the client device 902 and the application server 908, can be handled by the Web server. It should be understood that the Web and application servers are not required and are merely example components, as structured code discussed herein can be executed on any appropriate device or host machine as discussed elsewhere herein.

The data store 910 can include several separate data tables, databases or other data storage mechanisms and media for storing data relating to a particular aspect. For example, the data store illustrated includes mechanisms for storing production data 912 and user information 916, which can be used to serve content for the production side. The data store also is shown to include a mechanism for storing log data 914, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 910. The data store 910 is operable, through logic associated therewith, to receive instructions from the application server 908 and obtain, update or otherwise process data in response thereto. In one example, a user might submit a search request for a certain type of item. In this case, the data store might access the user information to verify the identity of the user, and can access the catalog detail information to obtain information about items of that type. The information then can be returned to the user, such as in a results listing on a web page that the user is able to view via a browser on the client device 902. Information for a particular item of interest can be viewed in a dedicated page or window of the browser.

Each server typically will include an operating system that provides executable program instructions for the general administration and operation of that server, and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 9. Thus, the depiction of environment 900 in FIG. 9 should be taken as being illustrative in nature, and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed, or removable storage devices as well as storage media for temporarily or more permanently containing, storing, transmitting, and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used or particular elements might be implemented in hardware, software (including portable software, such as applets) or both. Further, connection to other computing devices such as network input/output devices may be employed.

Storage media and computer-readable media for containing code, or portions of code, can include any appropriate media known or used in the art, including storage media and communication media, such as but not limited to volatile and non-volatile, removable and non-removable media implemented in any method or technology for storage or transmission of information such as computer-readable instructions, data structures, program modules or other data, including RAM, ROM, EEPROM, flash memory or other memory technology, CD-ROM, DVD, or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as that included in the phrase “at least one of X, Y, or Z,” unless specifically stated otherwise, is otherwise understood within the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, or at least one of Z in order for each to be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
receiving, by a computer system, a plurality of reviews associated with items offered at an electronic marketplace, the plurality of reviews categorized in a plurality of categories, the plurality of categories comprising at least an item provider category;
generating, by the computer system, a plurality of phrases based at least in part on the plurality of reviews;
for a particular category, determining, by the computer system, a key phrase from the plurality of phrases based at least in part on probabilities of use of the key phrase across the plurality of categories;
receiving a new review from a first computing device of an item recipient, the new review associated with an item offered by an item provider at the electronic marketplace;
receiving a request from a second computing device of the item provider to remove the new review;
categorizing the new review in a category of the plurality of categories based at least in part on matching the new review to a corresponding key phrase associated with the category; and
removing the new review if the category is different from the item provider category.

2. The computer-implemented method of claim 1, wherein determining the key phrase for the particular category comprises:
computing a first frequency of use of the key phrase in first reviews categorized in the particular category;
computing a second frequency of use of the key phrase in second reviews categorized in a second category of the plurality of categories;
determining a score for the key phrase based at least in part on the first frequency and the second frequency; and
determining that the score for the key phrase is the highest score among scores for phrases associated with the particular category.

3. The computer-implemented method of claim 2, wherein the score for the key phrase is based at least in part on a sum of fractions, wherein each fraction divides a numerator by a denominator, wherein each numerator comprises the first frequency of use, and wherein each denominator comprises a different frequency of use of the key phrase, wherein each different frequency of use is associated with a different category of the plurality of categories.

4. The computer-implemented method of claim 1, wherein determining a key phrase for the particular category is associated with an accuracy level, and wherein the accuracy level is independent of a written language of the reviews.

5. A computer-implemented method, comprising:
receiving categories associated with information;
generating, by a computer system, potential strings based at least in part on combinations of portions of the information;
for a potential string from the potential strings, determining, by the computer system, likelihoods of occurrence of the potential string in the categories, individual likelihoods of occurrence corresponding to a different category of the categories;
for a particular category from the categories, determining, by the computer system, a relevance of the potential string based at least in part on the likelihoods of occurrence; and
setting the potential string as a representative string for the particular category based at least in part on a comparison of the relevance of the potential string to another relevance of another potential string, the another relevance associated with the particular category.

6. The computer-implemented method of claim 5, wherein the potential strings comprise one or more of: reviews of an item, content of a document, comments to an article, texts from a blog, messages within a social network content, consumer complaints, or completed surveys.

7. The computer-implemented method of claim 5, wherein generating the potential strings comprises:
parsing the information to determine the portions;
removing particular portions from the determined portions; and
combining a plurality of remaining portions from the determined portions to generate a particular potential string.

8. The computer-implemented of claim 7, wherein the particular portions are determined based at least in part on locations of the particular portions in the parsed information.

9. The computer-implemented of claim 7, wherein a particular portion from the particular readable portions is determined based at least in part on matching the particular portion to a predefined set of portions of information, and wherein the matching comprises one or more of: an exact match, a similarity match, a root match, synonym match, or a variation match.

10. The computer-implemented of claim 7, wherein a particular portion from the particular portions is determined based at least in part on a comparison of a frequency of use of the particular portion in the information to a threshold.

11. The computer-implemented of claim 7, further comprises removing punctuations from the parsed information.

12. The computer-implemented of claim 7, wherein combining the plurality of remaining portion to generate the particular potential string comprises:
computing an average number of determined portions in the parsed information;
computing a deviation from the average number; and
determining a length for the particular potential string from a range of lengths, wherein the range is limited by a minimum number of portions and a maximum number of portions, wherein the minimum number and the maximum number are based at least in part on the average and the deviation.

13. The computer-implemented of claim 5, wherein the relevance comprises a likelihood of occurrence of the potential string in the particular category relative to likelihoods of occurrence of the potential string in remaining categories of the categories.

14. A system, comprising:
a memory that stores computer-executable instructions; and
a processor configured to access the memory and to execute the computer-executable instructions to collectively at least:
identify a first group and a second group, the first group and the second group comprising words;
generate word strings based at least in part on combinations of the words;
for a word string of the word strings, determine a relevance of the word string for the first group based at least in part on a first association of the word string with the first group and a second association of the word string with the second group; and
set the word string as a representative word string of the first group based at least in part on a comparison of the relevance to a threshold.

15. The system of claim 14, wherein the first association comprises a first probability of use of the word string relative to first existing word strings in the first group, and wherein the second association comprises a second probability of use of the word string relative to second existing word strings in the second group.

16. The system of claim 15, wherein the relevance of the word string is based at least in part on a score that combines the first probability of use and the second probability of use.

17. The system of claim 16, wherein the score comprises a division of the first probability of use by the second probability of use.

18. The system of claim 16, wherein the threshold is set as a highest score among scores of the word strings relative to the first group, and wherein the comparison indicates that the score of the word string is the highest score.

19. The system of claim 16, wherein the threshold comprises a predefined score, wherein the comparison indicates that the score of the word string exceeds the predefined score, and wherein the predefined score is set based at least in part on one or more of: an input specifying the predefined score, a range of acceptable scores among scores of the word strings relative to the first group, or a number of acceptable word strings.

20. One or more computer-readable storage media storing computer-executable instructions that, when executed by one or more computer systems, configure the one or more computer systems to perform operations comprising:
generating combinations of words, the words associated with first word strings, the first word strings associated with a first label;
for a first combination of words from the combinations of words, determining a first metric and a second metric, the first metric based at least in part on occurrences of the first combination in the first word strings, the second metric based at least in part on occurrences of the first combination in second word strings, the second word strings associated with a second label;
generating a first score for the first combination of words based at least in part on the first metric and the second metric; and
representing the first word strings with the first combination of words based at least in part on a comparison of the first score and a second score, the second score associated with a second combination of words from the combinations of words.

21. The one or more computer-readable storage media of claim 20, wherein representing the first word strings with the first combination comprises associating a new word string with the first label instead of the second label based at least in part on matching the new word string to the first combination of words.

22. The one or more computer-readable storage media of claim 21, wherein matching the new word string to the first combinations of words comprises matching words in the new word string to words in the first combination of words.

23. The one or more computer-readable storage media of claim 21, wherein the operations further comprise:
receiving a request to perform a requested action on the new word string;
determining a rule specifying an acceptable action based at least in part on the matching of the new word string to the first combinations of words; and
perform the acceptable action in response to the request.

24. The one or more computer-readable storage media of claim 23, wherein the request is associated with a user, wherein the requested action comprises dissociating the new word string with an identifier of the user, wherein the rule specifies that the acceptable action comprises the requested action if the first label is irrelevant to the user, and wherein the rule specifies that the acceptable action comprises notifying the user by way of a computing device that the requested action is denied if the first label is relevant to the user.
